(19) United States
(12) Patent Application Publication
(10) Pub. No.: US 2004/0080125 A1
(43) Pub. Date: Apr. 29, 2004

(54) Motorized lift for trailer dolly

(76) Inventors: Norman A. Bird, Middleville, MI (US); Robert L. Woodmansee, Hastings, MI (US)

Correspondence Address: Waters & Morse, P.C., 400 Ledyard Building, 125 Ottawa Avenue, NW, Grand Rapids, MI, 49503, US

(21) Appl. No.: 10/280,182

(22) Filed: Oct. 25, 2002

(51) Int. Cl. B60P 1/00

(52) U.S. Cl. 280/6.153

(57) ABSTRACT

A motorized lift for a trailer dolly that can be retrofitted onto an existing manual trailer dolly lift mechanism without disabling or impairing the manual lift capabilities of the lift mechanism comprises an electrical motor and an integral reduction gear assembly mounted on the leg of a trailer dolly and drivingly connected to an input shaft of the manual gearbox of the manual lift mechanism. An extension shaft on the input shaft makes the input shaft longer so that the manual crank can still be attached to the input shaft for manual operation of the lift. The motor drive assembly includes a manual disengagement button that permits the output shaft of the motor and reduction gear assembly to be disengaged and rendered free wheeling, so the motor drive does not impair manual crank operation.

### BACKGROUND OF THE INVENTION

The present invention relates to a motorized lift for a trailer dolly and in particular to an improved motorized lift that operates in all weather and permits alternative use of a manual crank or the motor drive for operating the dolly, in the event that the motorized lift fails.

Semi trailers are supported on legs at the front of the trailers when not mounted on a tractor support platform. The legs are telescoping and are extended by a leg drive mechanism mounted in each leg. A manual crank operates a manual gear mechanism attached to one leg and the gear mechanism rotates a transverse shaft called a trailer dolly lead screw. The lead screw extends from the gear mechanism through both legs on opposite sides of the trailer. The lead screw operates the leg drive mechanisms in order to extend and retract the legs. Generally, the manual gear mechanism is a manually selectable two-speed gear, where a high gear is used until a leg contacts the ground, and then a low gear is selected to raise the trailer upwardly from the ground.

A problem with a manually operated trailer lift is that the operation of the lift is slow, back-breaking work, requiring a substantial amount of time and creating a risk of injury to the employee.

A number of motor operated lift mechanisms have been developed. Some of these are operated pneumatically and some electrically. Pneumatic systems can conveniently employ the truck pneumatic system for power, but these systems can be unreliable in cold weather. A problem with prior electrical systems is that they do not easily provide for alternative manual or motorized lift, and those that do permit manual operation generally either require disconnecting the electrical system in order to operate the manual crank or require that the person operating the crank also turn the electrical drive components and speed reduction gears, which can require a great deal of additional effort and strain, if manual operation with the motor connected is possible at all.

An object of the present invention is to provide an unobtrusive, relatively inexpensive, and yet very reliable motorized drive mechanism for a trailer, wherein the motorized drive mechanism can easily be disengaged, in order to permit manual operation of the lift mechanism without being handicapped by an interconnected motor drive mechanism.

A further object of the present invention is to provide a simple and inexpensive motor drive mechanism that can easily be retrofitted on an existing trailer dolly.

### SUMMARY OF THE INVENTION

The present invention comprises a motorized lift for a trailer dolly wherein the motorized lift can easily and unobtrusively be retrofitted onto an existing manual trailer dolly lift mechanism without disabling the manual lift capabilities of the lift mechanism.

The present invention comprises a motor drive assembly including an electrical motor and an integrally connected reduction gear assembly mounted on a bracket attached to the leg of a trailer dolly. The motor assembly is oriented so that an output or drive shaft extends outwardly from the trailer so as to be positioned beside an input shaft of the manual gearbox on the leg of the trailer dolly. The input shaft and drive shaft are drivingly connected together by a chain drive. An extension shaft or stub shaft is mounted on the input shaft. This makes the input shaft longer so that the manual crank can still be attached to the input shaft on the outer side of the chain drive. The motor drive assembly employed in the present invention includes a manual disengagement feature that permits the motor and reduction gear assembly to be put into a neutral state by the actuation of a button on the motor. This renders the motor assembly drive shaft free wheeling and disengaged from the motor and reduction gears. The manual crank is normally disconnected from the manual gear mechanism but can easily be attached to the end of the stub shaft for manually operating the lift mechanism.

These and other advantages of the present invention will hereinafter appear, and for purposes of illustration but not of limitation, a preferred embodiment of the present invention is described in detail below and shown in the appended drawings.

### BRIEF DESCRIPTION OF THE DRAWINGS

FIG. 1 is a front elevational view showing the motorized lift mechanism of the present invention connected to a conventional trailer dolly or trailer lift mechanism.

FIG. 2 is a perspective view of the motorized lift mechanism of the present invention.

FIG. 3 is an plan view of the lift mechanism of the present invention.

FIG. 4 is a side elevational view of the lift mechanism of the present invention.

FIG. 4A is a plan view showing the interior of the manual gear box.

FIG. 5 is a front elevational view of the lift mechanism of the present invention.

FIG. 6 is an enlarged fragmentary plan view of the stub shaft connection between the trailer dolly lead screw and the manual crank.

FIG. 7 is a side elevational view of the stub shaft connection of FIG. 6.

FIG. 8 is a sectional view taken along line 8-8 of FIG. 7.

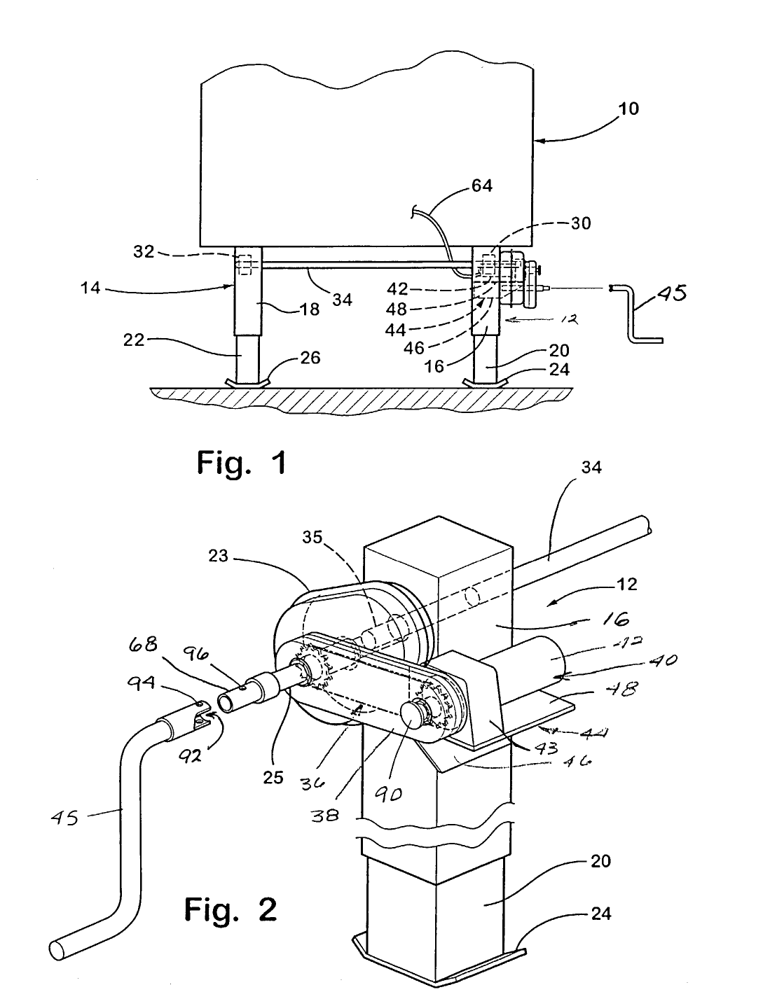

### DETAILED DESCRIPTION OF PREFERRED EMBODIMENT

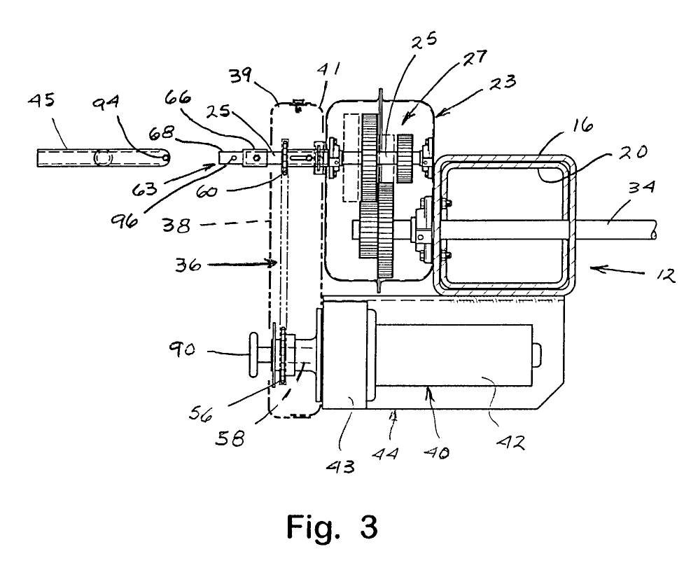

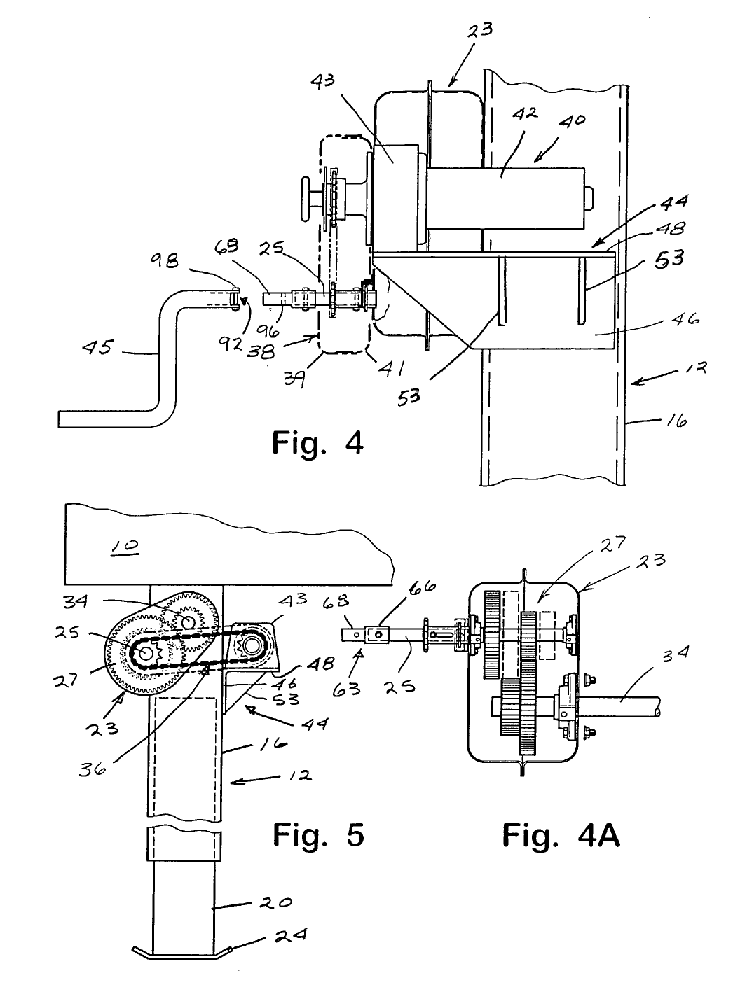

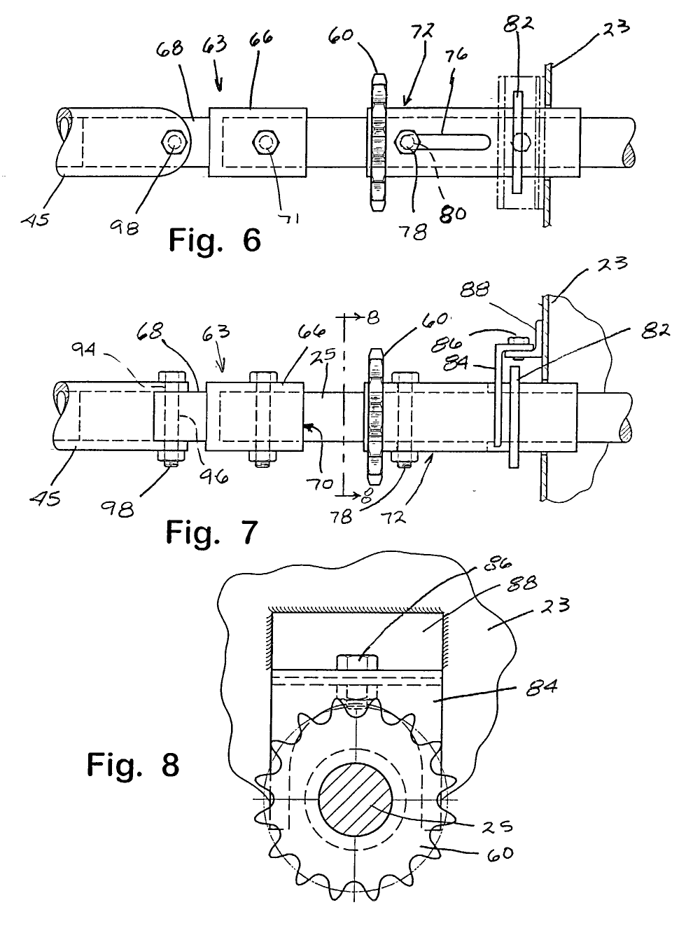

Referring to the drawings, a conventional trailer 10 is shown in FIG. 1, mounted on spaced telescoping legs 12 and 14 at opposite sides of the trailer. The legs are substantially identical and include upper sections 16 and 18 and lower sections 20 and 22 that telescope vertically in the interior of the upper sections, which are tubular. Feet 24 and 26 are positioned on the bottoms of lower legs 20 and 22. The legs incorporate gear or drive mechanisms 30 and 32 in the interior of the upper legs in order to extend and retract the telescoping leg mechanisms. These are conventional. The gear mechanisms are operated by a lead screw 34 that extends laterally between the legs at an upper position thereon. The lead screw extends through the upper portions of the legs. Lead screw 34 extends to an outer end 35 that protrudes through leg 12 and then engages a manual gear box 23 attached to the outer side of leg 12. This is conventional. Gear box 23 has an input shaft 25 which is rotated to rotate the lead screw through conventional internal gears 27. The gear box is a two speed gear box that can be shifted from low to high gear by pulling the input shaft outwardly. A chain drive mechanism 36 for the motor drive is mounted on the exterior side of the conventional manual gear box. Chain drive mechanism 36 is enclosed by a chain guard housing 38 comprising interfitting outer and inner sides 39 and 41, with inner side being bolted or otherwise attached in place to a motor assembly flange and outer side 39 fitting into inner side 41 and being attachable thereto by screws or the like. In a conventional lift mechanism, the manual gear box would be operated by a mechanical crank 45 (FIG. 3).

The motor drive or motorized lift mechanism 40 of the present invention comprises a motor 42, preferably a 12 DC volt electrical motor, and integrally connected reduction gear assembly 43 mounted on an angle bracket 44 that is attached to the side of upper section 16 of leg 12. The angle bracket runs outwardly from the side of the trailer and provides a vertical flange 46 for attachment to the leg and a horizontal flange 48 for mounting motor 42 thereon. Reinforcement flanges 53 extending between the horizontal and vertical flanges provide additional support for the horizontal flange The angle bracket desirably is welded to the leg but could be bolted to the leg if the attachment is secure. The motor drive reduction gear assembly 43 includes a housing, the front face of which is attached by screws or the like to chain guard housing member 41.

The motor drive is drivingly connected with the manual gear box input shaft 25 by means of a chain drive mechanism 36. Chain drive mechanism 36 includes a sprocket 56 mounted on the output shaft 58 of the motor drive and a corresponding sprocket 60 on the input shaft 25. A chain 62 interconnects the sprockets. In one aspect of the invention, sprocket 56 is a twelve tooth sprocket and sprocket 60 is a fifteen tooth sprocket. The chain drive mechanism desirably employs a heavy duty number 50 roller chain.

The input shaft 25 of the lift mechanism desirably is the same as the input shaft used in a purely mechanical gear system, but it is modified by fitting a stub shaft 63 on the end of the input shaft so a conventional crank mechanism 45 can be attached to the input shaft when desired in order to mechanically operate the lift mechanism. The stub shaft has enlarged end 66 and a narrower end 68. An opening 70 is formed in the enlarged end and fits over the end of the input shaft 25 and is bolted thereto by bolt 71. A sleeve 72 having sprocket 60 on an outer end fits over the input shaft 25 and extends inwardly to the manual gear box housing. A slot 76 in the sleeve fits over a bolt or pin 78 extending through an opening 80 in the input shaft. A washer or ring 82 is mounted on an inner end of the sleeve. The gear box can be shifted between a low and a high gear by axially moving the input shaft inwardly (low gear) and outwardly (high gear). However, the washer or ring 82 fixed on the stub shaft engages a U-shaped flange 84 on the outer side of the gear box 23 and holds the sprocket in place while the gear is changed. The flange 84 can be attached by a bolt 86 to a bracket 88 attached to the housing.

An important feature of the present invention is that a motor drive having an automatic disengagement feature is employed for the lift mechanism. Such motor drives are available commercially as winch drives. A commercial winch drive is satisfactory. A D.C. winch drive having a 148:1 reduction gear and a motor that develops 3000 pounds of torque is desirable. The motor includes a disengagement mechanism in the form of a button 90 that can be moved in or out in order to engage or effectively put the motor in a neutral gear and thus permit the output shaft of the motor to be rotated freely when the mechanical crank is operated. When the motor is operated, the mechanical crank is removed from the stub shaft. The motor is operated from the trailer or truck electrical system by means of an electrical lead 64 (FIG. 1).

To attach the crank, an opening 92 in the end of the crank is placed over the narrower end 68 of the stub shaft and the two are bolted together by bolt 98 through mating openings 94 and 96 in the crank and stub shaft. When the crank is operated, the motor is first disengaged in order to make the operation of the crank easier or possible.

The foregoing is merely exemplary of the preferred practice of the present invention. Various changes and modifications may be made in the arrangements and details of construction of this embodiment without departing from the spirit and scope of the present invention.

I claim:

1. A motorized lift for a trailer dolly wherein the trailer includes a manually operated lift mechanism comprising a manual gear box whereby a crank operated input shaft rotates a lead screw that in turn engages leg extension gear mechanisms in each of the trailer legs, the motorized lift comprising:
an electrical motor drive having a manually actuated switch that switches the motor drive between a drive mode, wherein the motor drive is drivingly engaged with an output shaft of the motor drive, and a disengaged mode, wherein the motor drive is drivingly disengaged from the output shaft of the motor drive so the output shaft is essentially free wheeling;
a mounting bracket attached to one leg of the dolly, the motor drive being mounted on the mounting bracket and being oriented so that the motor drive output shaft extends alongside the gearbox input shaft; and
a chain drive mechanism drivingly interconnecting the motor drive output shaft with the input shaft.

2. A motorized lift according to claim 1 wherein the lift includes an extension member drivingly connected to the input shaft that extends outwardly from the input shaft, the extension member being connectable with a manual crank for manually operating the lift mechanism by rotating the lead screw.

3. A motorized lift according to claim 2 wherein the motor drive includes a motor and reduction gear, the motor drive further including motor drive disengagement means for disengaging driving engagement between the motor and reduction gear from the motor drive output shaft so as to render the output shaft substantially free wheeling so as to facilitate use of the manual crank, the disengagement means being actuatable to engage or disengage the motor drive without disconnecting any of the components from the lift.

4. A motorized lift according to claim 3 wherein the motor drive disengagement means comprises a manually shiftable actuator member incorporated in the motor drive.

5. A motorized lift according to claim 1 wherein the manually operated lift mechanism includes a two speed gear mechanism, with the speed being shiftable by axial movement of the input shaft between extended and retracted positions, the chain drive mechanism including a sleeve non-rotatably but axially slidably mounted on the input shaft, a driven sprocket of the chain drive mechanism being mounted on the sleeve, the input shaft thus being axially movable without axial displacement of the driven sprocket.

6. A motorized lift according to claim 5 and further comprising a fixed position bracket on the manual gear box that engages the sleeve to restrict axial displacement thereof when the input shaft is axially displaced.

7. A motorized lift according to claim 5 wherein the sleeve is non-rotatably mounted on the input shaft so as to permit at least limited axial movement by means of a pin that extends through overlapping openings in sides of the sleeve and input shaft, with the opening in the side of the sleeve being a slot elongated in an axial direction.

8. A motorized lift according to claim 7 wherein the pin is a bolt that extends through the openings in the sleeve and input shaft.
